(19) United States
(12) Patent Application Publication
(10) Pub. No.: US 2019/0136827 A1
(43) Pub. Date: May 9, 2019

(54) Radial Piston Motor

(71) Applicant: Robert Bosch GmbH, Stuttgart (DE)

(72) Inventor: David Hare, Kirkliston (GB)

(21) Appl. No.: 16/183,814

(22) Filed: Nov. 8, 2018

(30) Foreign Application Priority Data
Nov. 8, 2017 (EP) 17200583.7

(51) Int. Cl. F03C 1/04; F03C 1/30; F03C 1/40

(52) U.S. Cl. CPC F03C 1/0422; F03C 1/0466; F03C 1/0412

(57) ABSTRACT

A radial piston motor includes a cam body and a working member. The cam body includes circumferentially arranged lobes. Each lobe includes a cam section for guiding a piston radially outwards. Each cam section includes a deceleration phase configured to radially decelerate an engaging piston in the case of constant rotational speed and an acceleration phase configured to radially accelerate an engaging piston in the case of constant rotational speed. The working member is rotatable relative to the cam body and has circumferentially arranged pistons. The number of pistons and the number of lobes have the number one as the only common factor and the numbers differ from each other. The deceleration phase is smaller than the acceleration phase.

This application claims priority under 35 U.S.C. § 119 to patent application number EP 17200583.7 filed on Nov. 8, 2017 in Europe, the disclosure of which is incorporated herein by reference in its entirety.

The present disclosure relates to a radial piston motor.

### BACKGROUND

A radial piston motor converts hydraulic pressure into rotation and includes a working member and a cam body. The working member comprises an array of hydraulically driven pistons arranged in the circumferential direction which engage via cam followers (e.g. rollers) with the cam body which comprises an array of lobes arranged in the circumferential direction and forming a cam profile. When hydraulic pressure urges the cam followers radially outwards against the cam profile in a timed fashion, a contact force arises causing the pistons to traverse the cam profile and the working member to relatively rotate. In the present application the term “traversing a section of [cam profile]” is understood to mean coinciding with the section, optionally making contact with the section.

It is known to provide an even number of both pistons and lobes, such as eight pistons and six lobes, or alternatively nine pistons and six lobes. These two cases (which can be abbreviated as 8P6L and 9P6L respectively) are two examples in which the number of pistons and the number of lobes have a common factor greater than 1 (2 for 8P6 Land 3 for 9P6L). In the former case, because 2 is a common factor, as the working member rotates relative to the cam body each particular piston traverses the same section of cam profile as another piston (here the other piston lying 180 degrees opposite the particular piston). In other words two pistons are active on the same shaped sections of cam profile. The number of lobes is equal to the number of strokes per piston revolution.

DE1007707B and GB938746 each disclose a radial piston motor having pistons and lobes wherein the number of pistons and the number of lobes have 1 as the only common factor and the numbers differ from each other.

### SUMMARY

It is an object of the disclosure to provide a radial piston motor having improved motor life for a given power density, and capable of reducing torque ripple. The object is achieved by the subject-matter disclosed herein. Advantageous further developments are subject-matter of the dependent claims.

A radial piston motor according to the disclosure comprises a cam body comprising circumferentially arranged lobes; and a working member rotatable relative to and provided inside the cam body and having circumferentially arranged pistons, wherein the number of pistons and the number of lobes have 1 as the only common factor and the numbers differ from each other; each lobe comprises a first cam section for guiding a piston radially outwards, and each cam section comprises: a deceleration phase configured to decelerate an engaging piston (a piston engaging with the deceleration phase) in the case of constant rotational speed; and an acceleration phase configured to accelerate an engaging piston (a piston engaging with the acceleration phase) in the case of constant rotational speed, wherein the deceleration phase is smaller than the acceleration phase.

Accordingly the number of pistons differs from the number of lobes, such that the named numbers have only 1 as common factor, wherein a cam curve is selected that has a first angle (piston deceleration phase at constant motor speed) that is smaller than a second angle (piston acceleration phase at constant motor speed).

Since the number of pistons differs from the number of lobes and 1 is the only common factor, the pistons coincide with (lie within) different portions of the cam profile at any instance during a complete rotation. In other words all of the pistons are acting against different sections of the cam profile, so the pistons do not receive the same frictional load profiles simultaneously. Torque ripple, which is an undesired variation in torque during each revolution of the working member relative to the cam body, is reduced.

Additionally, since the deceleration phase is smaller than the acceleration phase, the radius of curvature of a convex section of the cam profile is increased which decreases contact pressure for a given contact force and/or the radius of curvature of a concave section of the cam profile is decreased which also decreases contact pressure for a given contact force. Motor life can be increased for a given power density. Alternatively power density can be increased (by for example increasing lobe depth) while maintaining motor life. Furthermore the likelihood is reduced that more than one piston simultaneously traverses a deceleration phase during a rotation of the working member relative to the cam body, so torque ripple can be further reduced.

Each lobe may preferably comprise a second cam section for guiding a piston radially inwards, and further preferably the first and second cam sections may directly join each other at one or both ends of each cam section. Alternatively or in addition the first cam sections may have the same cam profile as each other. Alternatively or in addition the second cam sections may have the same cam profile as each other, which may further preferably be a mirror image of the cam profile of a first cam section.

The radial piston motor according to the disclosure may preferably have a reduced displacement mode (wherein one or more pistons are retracted (“turned off’)); the advantages of the disclosure can be achieved when the pistons return from their retracted states to their normal (i.e. cam-contacting) states.

The cam body of the radial piston motor may preferably be restricted from rotating, for example by being fixed to a housing.

Further preferably the pistons may be configured to contact the cam sections by means of cam rollers.

The radial piston motor may preferably be configured to have at least one rotational position at which exactly one piston lies within a deceleration phase. Rotational position is understood to mean the relative orientation between working member and cam body. In other words there is at least one point as the motor rotates at which exactly one piston is underneath an outward section of the cam track in its deceleration phase. High contact pressures can occur in a deceleration phase, and torque ripple is exacerbated when many pistons simultaneously reach deceleration phases, but the torque ripple can be kept low, since the number of rollers in a deceleration phase is exactly one at said rotational position. The aforementioned relationship between power density and motor life is further improved.

The radial piston motor may preferably be provided so that at any rotation angle at most one piston lies within a deceleration phase. Since high contact pressures can occur in a deceleration phase, any torque ripple exacerbated by any piston coinciding with a deceleration phase can be further reduced. The aforementioned relationship between power density and motor life is further improved.

Therefore torque ripple is further reduced because of the following synergistic factors: there is at least one rotational position at which exactly one piston lies within a deceleration phase, the contact pressure in the deceleration phase is reduced; and the contact pressure in the acceleration phase is reduced.

The radial piston motor may preferably be configured to have at least one rotational position at which exactly one piston engages with a deceleration phase. In addition the radial piston motor may preferably be configured to have at least one rotational position at which exactly one radially outward moving piston is radially decelerating when the working member rotates relative to the cam body at constant speed. Torque ripple is further reduced in each case. The aforementioned relationship between power density and motor life is further improved in each case.

Preferably the radial piston motor may be provided so that at any rotation angle at most one piston engages with a deceleration phase. In addition the radial piston motor may preferably be configured so that at most one radially outward moving piston is decelerating when the working member rotates relative to the cam body at constant speed. Torque ripple is further reduced in each case. The aforementioned relationship between power density and motor life is further improved in each case.

In a preferable embodiment the radial piston motor may additionally or alternatively have a number of pistons differing from the number of lobes by 1. Thus the number of lobes and number of pistons can kept high relative to each other. Turning forces and contact pressures are distributed between a large number pistons and lobes; one can further reduce torque ripple and improve the aforementioned relationship between motor life and power density.

In another preferable embodiment the radial piston motor may additionally or alternatively be provided so that either the number of pistons or the number of lobes is a prime number. In other words the number of pistons and the number of lobes are not both prime numbers. Therefore a radial piston motor having 1 as the only common factor can be achieved with a simple geometry, which facilitates aspects of its production such as manufacture, assembly and inspection.

In another preferable embodiment the working member may additionally or alternatively comprise at least eight (preferably eight) pistons. When the number of pistons is greater than seven, an advantageous relationship between torque ripple, power density, and part count is achieved. The advantage is particularly effected when the number of pistons is eight.

### BRIEF DESCRIPTION OF THE DRAWINGS

A preferable exemplary embodiment of the disclosure is explained in more detail in the following, with the help of schematic drawings, wherein like numerals are used to represent like elements and wherein:

FIG. 1 shows schematically a radial piston motor according to an exemplary embodiment.

FIG. 2 shows schematically a portion of the radial piston motor of FIG. 1.

FIG. 3 shows a graph that represents the radial velocity against rotational angle, of a piston in the radial piston motor according to the exemplary embodiment.

### DETAILED DESCRIPTION

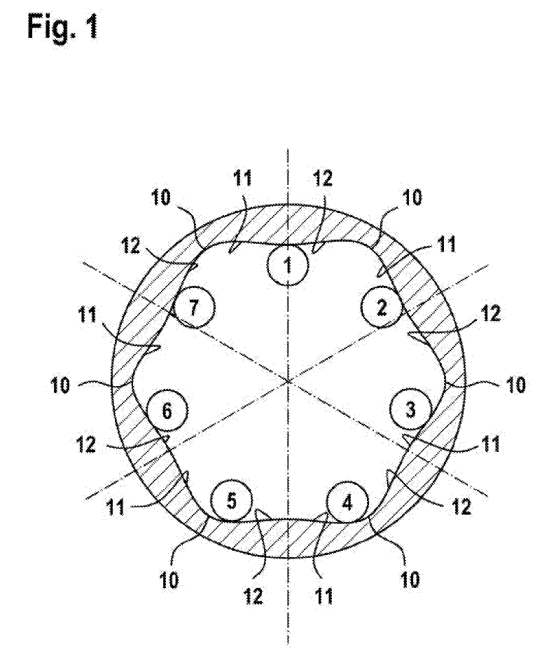

FIG. 1 shows, in schematic form, a radial piston motor according to an exemplary embodiment, comprising a cam body 13 and a working member.

The cam body 13 is essentially cylindrical and comprises six lobes 10 arranged (preferably equispaced) in the circumferential direction (arranged in a pattern in the circumferential direction). The lobes form a series of cam sections 11, 12, wherein each lobe comprises an inward cam section 11 and an outward cam section 12, both described in more detail further below. The lobes form a cam profile. The cam body 13 is preferably restricted from rotating e.g. by being fixed to a housing (not shown).

The working member is surrounded by the cam body 13 and is rotatable relative to the cam body 13, for example by being attached to the cam body 13 by means of one or more bearings. The working member comprises seven radially actuating pistons 1-7 which reciprocate in respective cylinders arranged (preferably equispaced) in the circumferential direction (i.e. the radially actuating pistons are arranged in a pattern in the circumferential direction). The working member is configured so that pressurizing a cylinder with fluid urges the respective piston radially outwards.

The pistons 1-7 are configured to engage with the lobes by making contact with the cam profile of the lobes via cam rollers, wherein one cam roller is provided for each piston. Each piston 1-7 is represented in FIG. 1 by its respective cam roller. In the following, “contact pressure” is understood to mean the surface pressure between a respective cam roller and the cam profile. To simplify the schematic of FIG. 1, the other parts of the working member such as cylinders and/or cylinder block are not shown.

By appropriately timed pressurization and depressurization of each cylinder, a respective piston is urged radially outward as it traverses an outward cam section so as to engage the cam section 12 (contact it via the cam roller), and the piston is not urged as it traverses an inward cam section 11. The resultant turning force causes the working member to rotate relative to the cam body 13.

In FIG. 1 the working member is understood to be rotating clockwise relative to the stationary cam body 13.

An inward cam section 11 is a cam section extending radially inwards as it extends circumferentially in the rotation direction, i.e. wherein the radial distance from the axis to an imaginary point on the inward cam section 11 decreases as the point moves along the cam section in the rotation direction; in other words the inward cam section 11 is configured so that a piston in contact with the inward cam section 11 will move inward in the radial direction as the working member rotates. The inward cam sections 11 share a common profile.

An outward cam section 12 is a cam section extending radially outwards as it extends circumferentially in the rotation direction, i.e. wherein the radial distance from the axis to an imaginary point on the outward cam section 12 increases as the point moves along the cam section in the rotation direction; in other words the outward cam section 12 is configured so that a piston in contact with the outward cam section 12 will move outward in the radial direction as the working member rotates. The outward cam sections 12 share a common profile which may correspond symmetrically with (may be a mirror image of) the profile of the inward cam sections 11.

The present exemplary embodiment comprises an arrangement of seven pistons 1-7 and six lobes. As the working member rotates, at any angular position of the working member relative to the cam body 13, the pistons 1-7 lie in different portions of the cam profile. For example the piston 3 lies in a different portion of the cam section from the piston 6 since piston 3 is underneath an inward cam section 11, while the piston 6 is underneath an outward cam section 12, so the piston 3 is moving radially inwards while the piston 6 is moving radially outwards. As another example, the piston 5 lies in an outward cam section 12, while the piston 6 lies in another outward cam section 12, but lies on a different portion of the outward cam sections' common cam profile. Therefore the pistons 1-7 lie in different portions of the inward cam section 11, and lie in different portions of the outward cam section 12.

The number of pistons and the number of lobes have 1 as the only common factor. The number of pistons and the number of lobes differ from each other, in particular differ by 1.

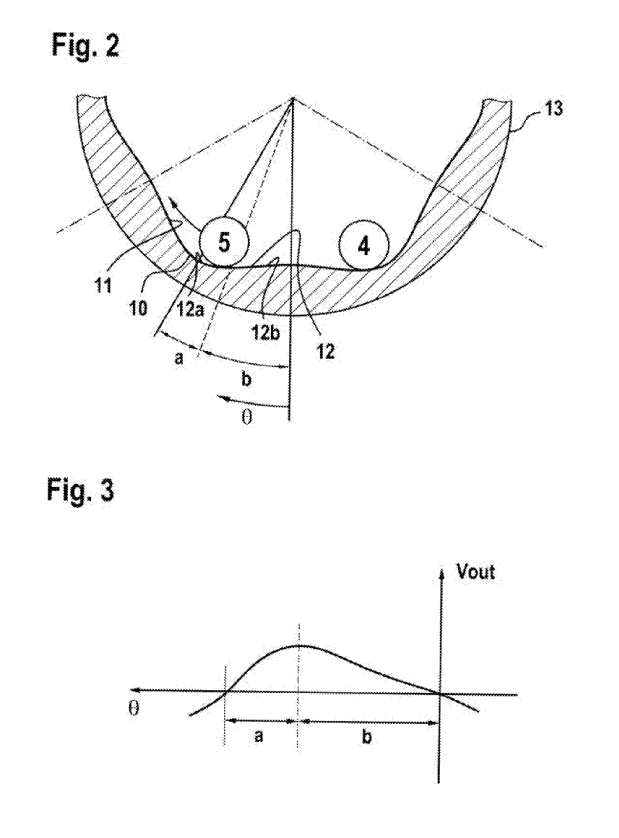

FIG. 2 shows schematically a portion of the radial piston motor of FIG. 1, the portion being the region around the piston 5. The description below applies to all lobes 1 O of the cam body 13 of the present exemplary embodiment.

The outward cam section 12 comprises an acceleration phase 12b defined by an angular range b, wherein the radial distance from the axis to an imaginary point on the acceleration phase 12b increases with an increasing rate as the point moves along the acceleration phase 12b in the rotation direction with constant rotational speed; in other words the acceleration phase 12b is configured so that a piston in contact with the acceleration phase 12b as the working member rotates with constant speed will move outward in the radial direction at an accelerating rate.

The outward cam section 12 comprises a deceleration phase 12a defined by an angular range a, wherein the radial distance from the axis to an imaginary point on the deceleration phase 12a increases with a decelerating rate as the point moves along the deceleration phase 12a in the rotation direction with constant rotational speed; in other words the deceleration phase 12a is configured so that a piston in contact with the deceleration phase 12a as the working member rotates with constant speed will move outward in the radial direction at a decelerating rate.

As can be seen from FIG. 2, the deceleration phase 12a is made smaller than the acceleration phase 12b (a<b). As a result the angular extent of each convex section of the cam profile is relatively increased, while the angular extent of each concave section of the cam profile is relatively decreased, compared to an example where the angular extents of convex and concave portions are equal.

FIG. 3 shows a graph that represents the radial velocity Vout of a piston (here piston 5 is used exemplarily) against the rotational angle 8 of the piston 5 as it traverses (passes over) the lobe 10. Radial velocity of a piston is measured relative to its respective cylinder. Positive velocity values represent radially outward movement, while negative velocity values represent radially inward movement, of the piston 5. The rotational angle 8 of the piston 5 is the angular position of the point of contact between the cam roller for the piston 5 and the lobe 1, and is represented on the x-axis. The origin of the x-axis is defined to be the vertical line in FIG. 2, which is the boundary between the outward cam section 12 of the lobe 10 and of the inward cam section 11 an adjacent lobe. The piston 5 is moving clockwise along the outward cam section 12 away from the origin of the x-axis (i.e. leftwards in FIG. 3). Thus the piston has passed through the acceleration phase 12b and is passing through the deceleration phase 12a of the outward cam section 12 of the lobe 10.

As can be seen from FIG. 3, the gradient (representing acceleration or deceleration in the radial direction) of the curve in the angular range a (deceleration phase 12a) is less than the gradient of the curve in the angular range b (acceleration phase 12b), and the angle a is smaller than the angle b. The gradient is zero at the boundary between the acceleration 12b and the deceleration 12a phases. The boundary is shown as a dashed line in FIGS. 2 and 3. Therefore the maximum radius of curvature of the cam profile in the acceleration phase 12b is greater than the maximum radius of curvature of the cam profile in the deceleration phases 12a.

The present exemplary embodiment has the following advantages.

Since the number of pistons and the number of lobes have 1 as the only common factor, the pistons 1-7 coincide with (lie within) different portions of the cam profile at any instance during a rotation, and the pistons 1-7 receive different friction loads from contact with the cam sections. Since different cam slope angles can cause different amounts of friction, any variation in torque (torque ripple), particularly at low speeds, is reduced compared to an arrangement wherein two or more pistons coincide (lie within) with the same shape of cam section at any instance during a rotation. This comparative example can occur when 2 or 3 is the common factor, for example. Accordingly two (or three, depending on the common factor(s)) pistons will encounter simultaneously a disadvantageous section of cam profile which is a section that gives rise to high contact stresses. A large torque ripple effect can result. When the only common factor is 1, only a single piston will encounter the disadvantageous section of the cam and therefore the torque ripple is decreased and the minimum torque is increased.

Furthermore, since the only common factor is 1, a more advantageous design of cam profile is possible with regard to power density and motor life performance. For example the deceleration phase 12a is made smaller than the acceleration phase 12b in the outward cam 12 of the present exemplary embodiment (a<b). This means that the radius of curvature on a convex cam section (e.g. in the outward cam section 12) is increased which in turn decreases the contact pressure for a given contact force arising from the piston being urged against the cam surface. The corresponding decrease of radius of curvature on a concave section (e.g. in the outward cam section 12) also decreases contact pressure. A decrease in contact pressure has the effect of increasing motor life. Alternatively, for a given motor life, an increase in power density is possible by increasing the depth or number of lobes 10. In other words the relationship between motor life and power density is improved. This is particularly advantageous for low speed applications, e.g. slew motors which are not required to have a two speed functionality.

The number of pistons differs from the number of lobes by 1. A difference of 1 allows for a high number of pistons and lobes relative to each other, which reduces torque ripple and improves the relationship between power density and motor life.

In addition when the radial piston motor has at least one position at which exactly one piston lies in a deceleration phase, torque ripple can be reduced because the occurrences of a plurality of pistons entering deceleration phases simultaneously, and/or the number of pistons entering deceleration phases simultaneously can be reduced.

The disclosure is not limited to an arrangement of seven pistons and six lobes. Any number of lobes and pistons is possible provided that the number of lobes differs from the number of pistons and that the only common factor between these two numbers is 1. Preferably eight or more pistons (further preferably eight) provides an advantageous relationship between motor life, power output, and simplicity of construction (in particular part count).

The radial piston motor according to the disclosure may preferably have a reduced displacement mode (wherein one or more pistons are retracted (“turned off’)). That is to say one or more pistons no longer move in and out with the cam sections. For example it may be provided for a single piston to be cam-contacting so as to decelerate whilst moving outwards when the other pistons are in their retracted state (but would not be decelerating simultaneously with the single piston if they were cam-contacting). The above-described advantages can still be achieved when the pistons return from their retracted states to their normal operational (i.e. cam-contacting) states.

The disclosure is not limited to comprising cam rollers. Instead of cam rollers, the pistons can contact the cam profile directly.

Disclosed is a radial piston motor including a cam body and working member rotatable relative to the cam body, inside the cam body. The cam body comprises lobes arranged in the circumferential direction. The working member comprises pistons arranged in the circumferential direction. Each lobe comprises cam sections configured to engage the pistons, including an outward cam section. Each outward cam section comprises a first angular range in which a piston decelerates at constant motor speed, and a second angular range in which a piston accelerates at constant motor speed; the first angular range is smaller than the second angular range. The number of pistons and the number of lobes have 1 as the only common factor and the numbers differ from each other. The radial piston motor may be configured to have at least one point in its rotation at which exactly one piston traverses, so as to coincide with (or lie within), the first angular range, at any time during a complete rotation.

### REFERENCE SIGNS

1 to 7 piston
10 lobe
11 inward cam section
outward cam section
12a deceleration phase
12b acceleration phase
13 cam body
a angular range of deceleration phase
b angular range of acceleration phase
e rotational angle of piston

1. A radial piston motor, comprising:
a cam body including a plurality of circumferentially arranged lobes, each lobe including a cam section configured to guide a piston radially outwards, each cam section including
a deceleration phase configured to radially decelerate an engaging piston in a case of constant rotational speed; and
an acceleration phase configured to radially accelerate an engaging piston in the case of constant rotational speed; and
a working member configured to be rotatable relative to the cam body, disposed inside the cam body, and including a plurality of circumferentially arranged pistons,
wherein a common factor of the total number of pistons of the plurality of circumferentially arranged pistons and the total number of lobes of the plurality of circumferentially arranged lobes is one,
wherein the common factor of one is the only common factor,
wherein the total number of pistons differs from the total number of lobes, and
wherein the deceleration phase is smaller than the acceleration phase.

2. The radial piston motor according to claim 1, wherein, in at least one rotational position, exactly one piston lies within the deceleration phase.

3. The radial piston motor according to claim 2, wherein, in at least one rotational position, exactly one piston engages with the deceleration phase.

4. The radial piston motor according to claim 1, wherein, in at least one rotational position, exactly one piston that is moving radially outwardly radially decelerates when the working member rotates relative to the cam body at constant speed.

5. The radial piston motor according to claim 1, wherein the total number of pistons differs from the total number of lobes by one.

6. The radial piston motor according to claim 1, wherein either the total number of pistons or the total number of lobes is a prime number.

7. The radial piston motor according to claim 1, wherein the plurality of circumferentially arranged pistons includes at least eight pistons.
